(19) United States
(12) Patent Application Publication
(10) Pub. No.: US 2004/0237032 A1
(43) Pub. Date: Nov. 25, 2004

(54) Method and system for annotating audio/video data files

(76) Inventors: David Miele, Brooklyn, NY (US); Frank Moretti, Bronx, NY (US); David Vanesselstyn, New York, NY (US); Maurice Matiz, New York, NY (US)

Correspondence Address: BAKER & BOTTS, 30 ROCKEFELLER PLAZA, NEW YORK, NY, 10112

(21) Appl. No.: 10/489,940

(22) PCT Filed: Sep. 26, 2002
(86) PCT No.: PCT/US02/30674

Related U.S. Application Data
(60) Provisional application No. 60/325,322, filed on Sep. 27, 2001.

(51) Int. Cl. G06F 17/21

(52) U.S. Cl. 715/512

(57) ABSTRACT

One or more audio/video files are provided on a central server (203), accessible via a computer network. A audio/video file is requested by a user (205) and the file is transmitted to that user for viewing (207). The user enters edit point information specifying a portion of the previously-transmitted audio/video file relating to which the user wishes to make an annotation. The edit point information is received (209) by the central server over the computer network along with the textual annotation entered by the user. Use may be made of an optional rule that the edit point information must satisfy before it is accepted (211). The received edit point information and textual annotation are stored in an annotation data file (213). A subsequent user may request the annotation data file, which is transmitted to that user. The annotation text along with the relevant portion of the audio/vide file is then displayed for the requesting user.

### RELATED APPLICATION

This application claims priority from U.S. provisional application No. 60/325,322 entitled “Web-Based Video Editing Tool,” filed on Sep. 27, 2001, which is incorporated by reference herein in its entirety.

### BACKGROUND OF INVENTION

Many educational environments make use of “case-based” learning, wherein students learn through both classroom lectures and discussions as well as through examinations of real-world applications of the techniques and strategies that they are being taught in the classroom. For example, in the field of social work, it is advantageous for students to watch an experienced practitioner interact with a client in the “field” and/or to watch other students engage in role playing with one another or with instructors, in addition to their in-class lectures.

Previous techniques that allowed students to view an experienced social worker interacting with a client made use of facilities with one way mirrors and sound systems. This allowed students to view such interactions live and discuss the interactions in a group without disturbing those interactions. Live viewing of “in field” interactions, however, is not always possible either because not all students and faculty can be present at the place and time of the interaction, because the facility is typically not large enough to accommodate all of the students and faculty and for other reasons. Although it is possible to videotape these interactions for later review by students, this approach presents several drawbacks. First, the practice of watching video tapes in class takes valuable class time away from lectures and other student-student and student-faculty discussions. Distributing videotapes to students to watch on their own presents other problems, such as the time and cost of preparing copies of the videotapes. More problematic is the lack of educational discourse that occurs when all of the students are not present to discuss their impressions of the video and the interactions depicted therein. For example, a student may wish to discuss a particular portion of the video with other students and/or faculty. This will require the student to wait until a subsequent class session to make his comments. Further, it will require the student, in a subsequent in-class session, to recount that portion of the video he wishes to discuss before he launches into his analysis of that portion of the video. In addition to the obvious drawbacks of requiring students to delay making their comments until a class session and consuming the class session with a description of the video portion to be discussed rather than immediately moving to the more productive discussion itself, there is also no assurance that the other students and/or faculty will remember the portion of the video that the student wishes to discuss.

### SUMMARY OF THE INVENTION

It is an object of the present invention to overcome these and other limitations of previous methods of analysis of audio/video material by providing a method of annotating portions of audio/video files.

In one exemplary embodiment of the present invention a method is provided wherein one or more audio/video files to be annotated is provided on a computer server. An annotating individual makes a request to listen to or view the file to be annotated. The requested file is then transmitted over a computer network for display to the annotating individual. When the annotating individual desires to annotate the audio/video file, he specifies a portion of the video he wishes to annotate which is received as edit point information. Text corresponding to the specified portion of the audio/video file is also received from the annotating individual. The received text and edit point information is then stored in an annotation data file.

In a further exemplary embodiment of the present invention, a request for a previously stored annotation data file is received from a requesting individual. The annotation data file is then provided over a computer network for display to the requesting individual so that the portion of the audio/video file specified in the edit point information in the requested annotation data file is displayed to the requesting individual along with the corresponding text.

In yet another exemplary embodiment of the present invention, a rule that the edit point information must satisfy is provided and any edit point information is processed to verify that the rule is satisfied. In this embodiment, the received text and edit point information is not stored in an annotation data file until the received edit point information satisfies the rule.

### BRIEF DESCRIPTION OF THE DRAWINGS

For a more complete understanding of the present invention, reference is made to the following detailed description of a exemplary embodiments with reference to the accompanying drawings in which:

FIG. 1 is a schematic diagram of an exemplary system for carrying out the present invention;

FIG. 2 illustrates a flow diagram of an exemplary method in accordance with the present invention;

FIG. 3 illustrates a flow diagram of an exemplary method for use in the method illustrated in FIG. 2;

FIG. 4 illustrates a user interface for use in the method illustrated in FIG. 2;

FIG. 5 illustrates a user interface for use in the method illustrated in FIG. 6; and

FIG. 6 illustrates a flow diagram of an exemplary method in accordance with the present invention.

### DETAILED DESCRIPTION OF THE EXEMPLARY EMBODIMENTS

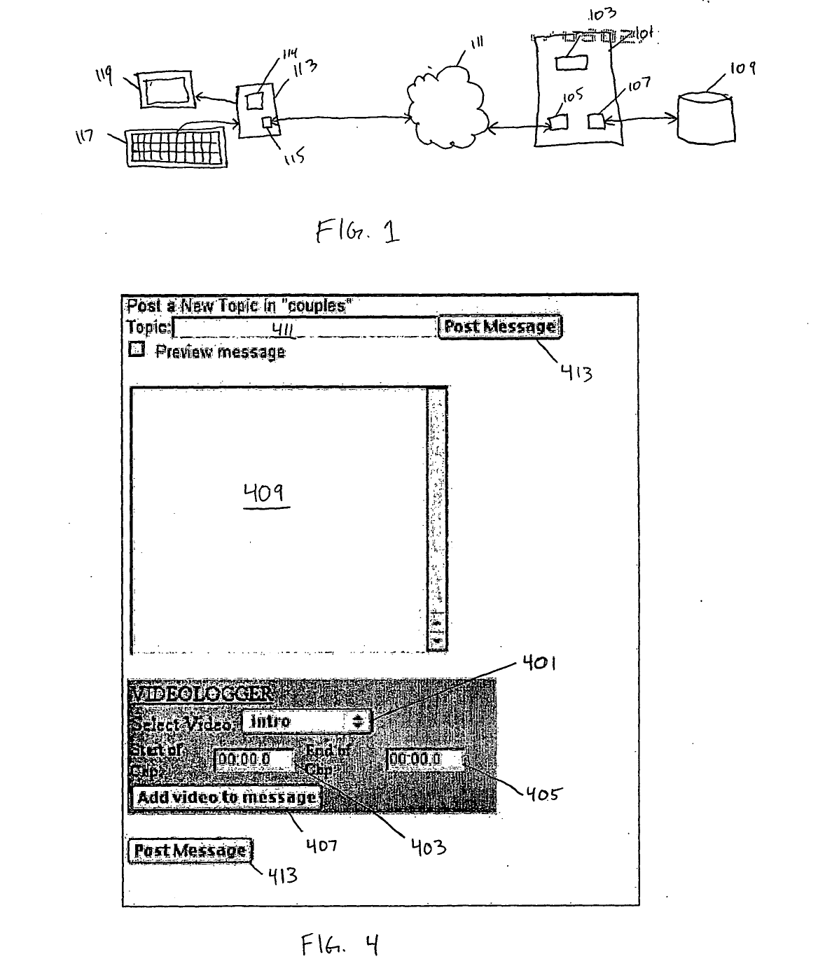

In FIG. 1 is illustrated an exemplary system for implementing the present invention. A user seeking to view and annotate an audio/video file accesses the annotation system via computer 113. Although only one computer 113 is illustrated, it will be understood that numerous computers could be used in accordance with the present invention. Computer 113 may be any general purpose computer capable of displaying audio/video files and permitting the user to input annotations. The computer 113 may be a conventional desktop or laptop personal computer. Alternatively, computer 113 may be a portable computing device, such as a personal digital assistant (PDA) or mobile telephone having data processing capabilities for implementing the present invention. Computer 113, in an exemplary embodiment, is operatively programmed to run a web browser, such as Microsoft's Internet Explorer™ or Netscape's Navigator™. Computer 113 is also operatively programmed to run a web browser extension, or “plug-in” capable of displaying audio/video files within the browser application, such as RealOne™ player from Real Networks™ or the QuickTime™ player from Apple Computer, Inc.

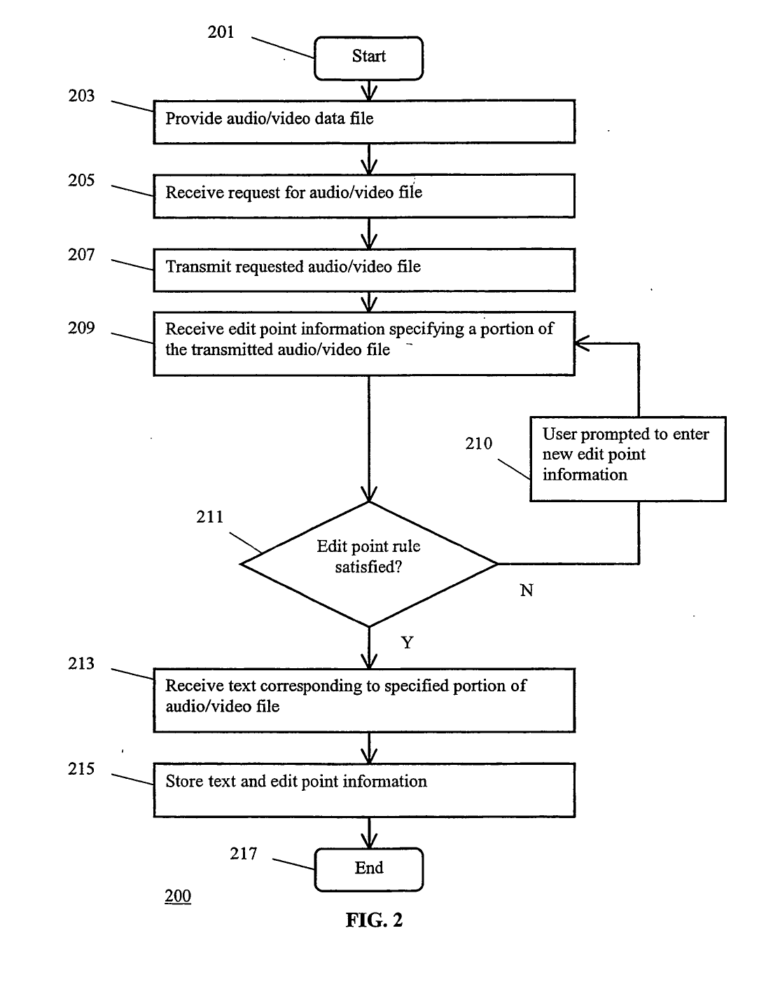

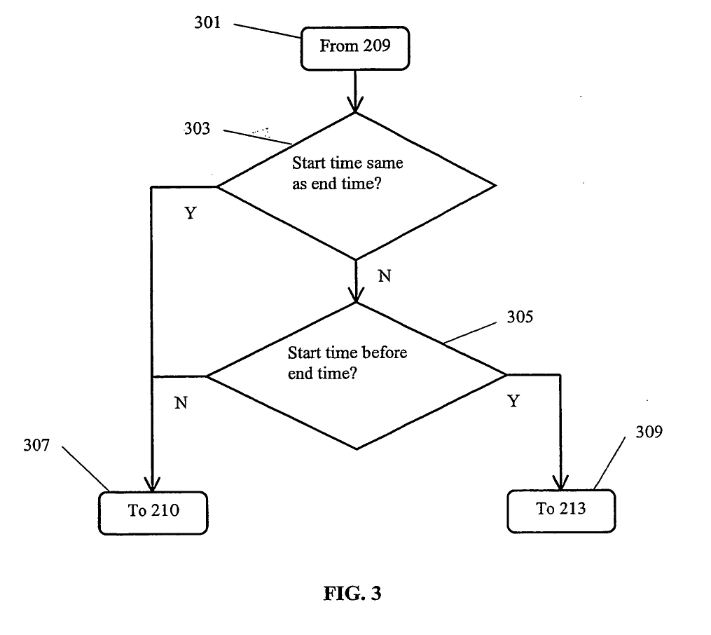

Execution of the web browser application by the computer 113 enables a user to cause audio/video files to be displayed on computer display screen 119, such as a CRT or LCD display. A request to view an audio/visual file and/or a stored message file may be indicated by the user manipulating input device 117, such as a keyboard or computer mouse. Selecting portions of the received audio/video file to annotate and the textual annotations may also be entered using input device 117. Details of the annotation process are described in detail herein with reference to FIGS. 2-3.

Information to and from the computer 113 is transmitted through network interface device 115, such as an Ethernet card, computer modem, or other device capable of interfacing computer 113 with computer network 111. The information is transmitted over computer network 111, such as the Internet. Through this network connection, computer 113 is in communications with server 101. Although only one server 101 is shown, it will be understood that the system could make use of multiple servers, each performing a particular function such as web page hosting, audio/video file hosting, etc. Server 101 includes controller 103, which may be any microprocessor-based system capable of performing the functions required by the present invention. In one exemplary embodiment, controller 103 is an Intel Pentium™ processor-based system running a webpage hosting application. Server 101 also includes a network interface device 105, similar to network interface device 115, which acts as a receiver and transmitter for receiving and transmitting information over network 111 to another computer applied to the network, such as computer 113. Also present in the exemplary embodiment of server 101 is a storage device interface 107 for interfacing with storage device 109 such as a hard disk-drive-based file server or hard drive. Storage device interface 107 may be identical to network interface device 105 where storage device 109 is a remote file server. Alternatively, storage interface device 107 may be any well-known interface with a storage device, such as a SCSI or EIDE controller. Although storage device 109 is illustrated as being separate from server 101, it will be understood that storage device 109 may be internal to server 101. Also, the server 101 may make use of multiple storage devices 109.

One exemplary embodiment of a method of the present invention is illustrated by the flow diagram 200 in FIG. 2. The method begins at step 201 and advances to step 203, where one or more audio/video files are provided for review and annotation by users in accordance with the invention. Audio/video files may be any digital data file containing audio and/or video (including still images) data that users of the method according to the present invention may wish to review and comment upon. In one exemplary embodiment, audio/video files are movies of a social worker interacting with a client or clients and the files are encoded in the Real Media™ format, in a process well-known to one of ordinary skill in the art. The present invention is not limited to such an embodiment however. Audio/video files of the present invention may include-traditional audio/video content such as television shows, movies, commercials and home videos. In another exemplary embodiment, the audio/video file consists of a sequence of pictorial images depicting a scene or event. Thus, rather than a traditional video file, where motion between successive images appears smooth to observers, these sequential still images may depict jerky movement, or may not depict movement at all, such as where the time between images is too large to show movement or where the images are captured from different angles to show different aspects of a larger event. For example, the audio/video file may be several sequential still images of a sporting event or a portion of a sporting event, such as a single play.

The method proceeds to step 205 where a request for one of the audio/video files is received. In an exemplary embodiment, the request is received via the Internet at a server computer, such as computer server 101 shown in FIG. 1, from a requesting user at a viewing computer, such as computer 113, also shown in FIG. 1. In an exemplary embodiment of the invention for use in an educational environment, a web page is created associated with the learning environment. For example, the webpage may be associated with a particular class being taught at an educational institution. The web page may have links to or otherwise list available audio/video files associated with the class. The web page may be served from the same computer server that serves the audio/visual files, or it may be served from a different server. The audio/video file server may be running, for example, the RealSystem™ Server application from RealNetworks, Inc. of Seattle, Wash.

Upon receiving the request for a particular audio/video file, the method moves to step 207, where the requested file is transmitted to the computer of the requesting user. In an exemplary embodiment, the file is streamed over the Internet from the RealSystem™ Server to the requesting user's computer, where the file is received and displayed for viewing by the requesting user by software running in the user's computer. The software running in the user's computer may be, for example, the RealOne™ Player from RealNetworks, Inc., executing in conjunction with a web browser application, such as Internet Explorer™ from Microsoft Corporation of Redmond, Wash. In the exemplary embodiment where the audio/video file is a sequence of images, those images may be shown in sequence, such as in a slideshow fashion, using techniques well known to one of ordinary skill in the art.

Upon receipt of the audio/video file, the requesting user is able to watch the video and/or hear any associated audio on his computer. If after viewing the file, the user desires to comment upon or otherwise annotate a particular portion of the audio/video file, he may make note of the start and stop time of the relevant portion. In an exemplary embodiment, the user is able to determine the start and stop times of the relevant portion by observing a time code that is displayed during the display of the video at the start and stop points of the relevant portion of the file. The time code may be displayed as a feature of the software that displays the audio/video file, such as the RealOne player. In another exemplary embodiment where the audio/video file is a sequence of still images, where each image has a name and/or frame number, the user may make note of image names or frame numbers rather than start and stop times.

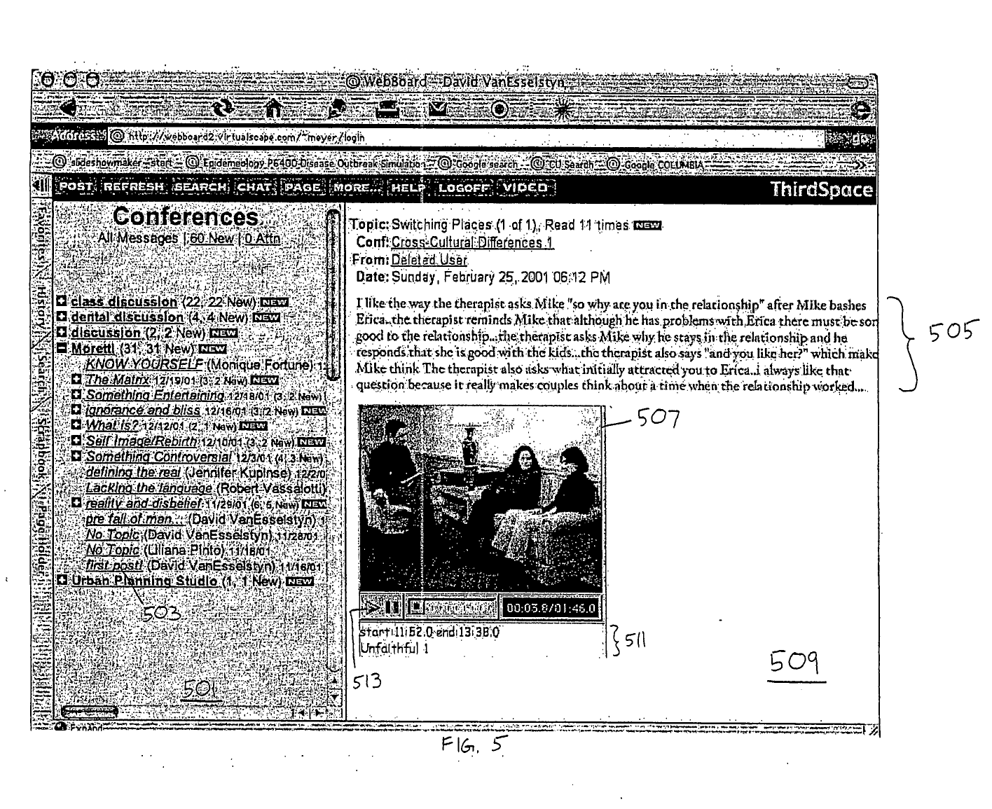

Should the user decide to provide an annotation commenting upon a particular section of the audio/video file, the process proceeds to step 209 where edit point information is received from the user. In one exemplary embodiment, illustrated in FIG. 4, the user will input the relevant edit point information, such as the start and stop time of the relevant selection of the file into a web page form. For example, the user may first select the name of the audio/video file which he wants to annotate by clicking the name of the file in drop-down selector 401 with a computer mouse input device. The user may then input the start time of the relevant selection he wishes to annotate in text box 403. The user may also input the stop time of the relevant section into text box 405. The user may then click the “Add video to message” button 407 to indicate completion of the entry of edit point information. Other techniques for entering edit point information will be apparent to one of ordinary skill in the art, including the use of graphical user interface elements such as slide-bars to accept the edit point information from the user. These alternative techniques may obviate the need to display time code information to the user watching the requested video. Exemplary JavaScript computer code used to generate a web page input screen as shown in FIG. 4 is attached hereto as Appendix A.

In another exemplary embodiment where the audio/video file is a sequence of still images, the user may enter individual image names and/or frame numbers to specify the edit point information. For instance, where the audio/video file is a sequence of still images depicting a single play of a baseball game, the user may select one or more images depicting the pitch, one or more images depicting the batter swinging and one or more images depicting the ball in play and associated activity. These frame numbers may be entered in a text box in similar fashion to that depicted in FIG. 4, or may be entered via other methods well known to one of ordinary skill in the art.

In one exemplary embodiment of the present invention, use is optionally made of a rule that the edit point information must satisfy before the it will be accepted for storage. The use of an edit point rule is illustrated in optional step 211. If the edit point information entered by the user satisfies the rule, or if optional step 211 is not utilized, the process proceeds to step 213. If the edit point information does not satisfy the rule, the process returns to step 209 where after the user is prompted in step 210, new edit point information is received from the user. The processing required during optional step 211 may be performed on the user's computer, such as computer 113 in FIG. 1, before the edit point information is transmitted to a central sever, or the processing may be performed on a central sever, such as server 101 illustrated in FIG. 1, after the edit point information is transmitted. Alternatively, the processing may occur at both the user's computer and the central server.

Further detail of an optional edit point information rule for use in step 211 is illustrated in FIG. 3. In the illustrated embodiment, the edit point rule requires the start time entered by the user to be different from and earlier in time than the stop time entered by the user. In this exemplary embodiment, the process starts at step 301 and proceeds to step 303 where a determination is made as to whether the edit point start time is the same as the edit point end time. If the start time and stop time are the same, the rule is not satisfied as indicated by step 307 and the process returns to step 209 after carrying out step 210, as previously described with reference to FIG. 2. If the start and stop time are not the same, the process proceeds to step 305, where a determination is made as to whether the start time entered by the user is before the end time entered by the user. If the start time is before the stop time, the rule is satisfied as indicated by step 309 and the process proceeds to step 213, described in detail herein. If the start time is not before the stop time, the rule is not satisfied as indicated by step 307 and the process returns to step 209 after carrying out step 210, as previously described.

In step 213, text entered by the user corresponding to the portion of the audio/video file specified by the edit point information is received. In an exemplary embodiment, the user enters text corresponding to the specified portion of the audio/video file using the form illustrated in FIG. 4. The textual annotation is entered in text box 409. Once the user is satisfied with his textual entry, he may click on either of the two “Post Message” buttons 413 using the computer mouse to transmit the text message, which is then received as reflected in step 213.

The text entered by the user may relate entirely to the specified portion of the audio/video file or may only relate in part to the specified portion. In an exemplary embodiment, the text is entered by a student or instructor involved in an educational endeavor. Thus, the textual annotation may consist of an instructor's comments regarding a particularly instructive portion of the audio/video file, or may be a student's question about a portion of the audio/video file. In another exemplary embodiment where the audio/video file depicts a sporting event, the annotation may include textual information about the depicted event, such as the names of the players involved in the depicted play, the score of the game depicted, or other textual information associated with the displayed images. Numerous other applications of the present invention are possible and the nature of the textual annotation is as varied as the nature of those numerous applications. The textual annotation may be plain text, formatted text and/or may include links to other documents or files, accessible via electronic means such as via the Internet, that relate, at least partially, to the selected audio/video segment.

In step 215, the received edit point information and received text are stored in an annotation data file. In one exemplary embodiment, the annotation data file is in the hypertext markup language (HTML) and includes both the text annotation as well as the edit point information. For example, the annotation file may consist of the textual annotation followed by HTML code that, when received and executed by a user's web browser, instructs the user's web browser to retrieve the specified portion of the annotated audio/video file. Exemplary HTML code to be appended to a textual annotation that would instruct a user's browser to retrieve an audio/video file named “sipakatznelson.rm” from an audio/video file server named “kola.cc.columbia.edu” and display the section of that file beginning at time 00:50.0 and ending at time 1:50.0 is attached hereto as Appendix B. As previously discussed, the web browser may make use of add-on or “plug-in” software to assist in the function of retrieving and displaying the audio/video files. In one exemplary embodiment, the web browser makes use of the RealOne™ player plug-in. The process then terminates at step 217.

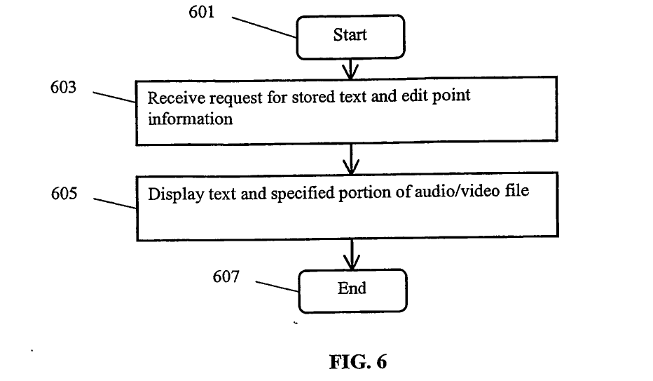

An exemplary embodiment of the present invention for use in viewing previously stored annotation files is now explained with reference to FIGS. 5 and 6. Referring to the flow diagram 600 in FIG. 6, the process begins at step 601 and proceeds to step 603 where a request from a user for stored text and edit point information is received. In the exemplary embodiment illustrated in FIG. 5, the user communicates his request by selecting a message identifier 503 from a list 501 presented on a web page at a website. The user may indicate the selected message by clicking on a corresponding identifier 503 with a computer mouse. The request is then transmitted by the user's web browser to a web server computer, which receives the request. In another exemplary embodiment, the annotation may automatically be requested by the user's computer on a periodic basis.

Referring again to FIG. 6, the process proceeds to step 605 where the requested text and audio/video file portion specified by the associated edit point information is displayed. In the exemplary embodiment illustrated in FIG. 5, this is achieved by transmitting the previously-stored annotation file, which, as previously described, contains the annotation text and associated edit point information in HTML format, from the web server to the user's computer. The annotation file is received by the user's web browser, which renders the HTML file into a form suitable for viewing, such as by rendering and presenting the file in frame 509 shown in FIG. 5. As can be seen, the displayed file includes annotation text 505 as well as moving and/or still images from the audio/video file 507. Only the portion of audio/video file 507 that was previously selected through entry of edit point information by the user authoring the annotation is displayed. In the example illustrated in FIG. 5, the author of the annotation had selected the portion of the video entitled “Unfaithful 1” beginning at 11:52.0 and ending at 13:38.0, as indicated in audio/video information field 511. The specified portion of the audio/video file 507 will be played for the requesting user when the user selects the play button 513, such as by clicking the button 513 with a computer mouse. Referring again to FIG. 6, the process then proceeds to terminate at step 607.

Although the present invention has been described by way of detailed exemplary embodiments, it should be understood that various changes, substitutions and alterations can be made hereto without departing from the scope or spirit of the invention, the scope of the invention being defined by the appended claims. For example the system could easily be adapted to audio/video files containing only audio or video/pictorial data. Moreover, while the invention has been described with reference to educational and entertainment type environments, the system has applicability to other environments where shared annotations of audio/video files would be advantageous, such as in a collaborative working environment. Further, while the exemplary embodiments described made use of web browsing software and associated plug-ins, it will be apparent to one of ordinary skill in the art that customized applications could be used in addition to or in lieu thereof to perform the features of the present invention. For example, rather than storing the annotation files on a web sever that are subsequently accessed using a web browser by other users of the annotation system, the annotation files may be stored on a e-mail sever and transmitted to an addressee specified by the author of the annotation. Alternatively, the files may be stored on an internet based instant messaging server, allowing real-time annotations of files in an instant messaging or chat-room environment. Such an embodiment would be useful where the annotations are only to be shared among a few individuals rather than a relatively large number of individuals.

```
APPENDIX A
<head>
<title>Untitled Document</title>
<meta http-equiv=“Content-Type” content=“text/html; charset=iso-8859-1”>
</head>
<body bgcolor=“<wb-clr_background>” text=“<WB-clr_right_text>” link=“<WB-
clr_right_link>” vlink=“<WB-clr_right_vlink>” alink=“<WB-clr_right_alink>”>
<script language=“JavaScript1.2”>
//<!--
var clip = new Array(2)
var movie_final, movie_final_text
var numofclips
numofclips = 0
function selectMovie(loc, loc_final) {
urlprefix = ‘http://kola.cc.columbia.edu:8080/ramgen/itcmedia/tc/culturalstudies/’
urlsuffix = ‘?embed’
movie_final = urlprefix + loc + urlsuffix;
movie_final_text = loc_final;
//alert(‘movie_final is:\n’ + movie_final + ‘\n movie_final_text is:\n’ +
movie_final_text)
}
var videowindow = null;
function openvideowindow(url)
{
      if ((videowindow == null) ∥ (videowindow.closed)) {
            videowindow =
window.open(“http://www.columbia.edu/ccnmtl/draft/davidvan/thirdspace_videotools
/u6800/video.html”,“video”,“width=390,height=390,resizable,scrollbars,notoolbar”);
    if (!videowindow.opener) videowindow.opener = self;
      }
      else{
            videowindow.focus( );
            videowindow.location =
“http://www.columbia.edu/ccnmtl/draft/davidvan/thirdspace_videotools/u6800/video.
html”;
      }
}
function generateCode( ) {
if (numofclips < 2) {
if (movie_final_text == ‘Select Video Clip:’ ∥ movie_final_text == null) {
  alert(‘Third Space Error:\n\nPlease select a video clip to reference.’)
} else {
  if (document.form3rdspace.clipStart.value ==
document.form3rdspace.clipEnd.value) {
            alert(‘Third Space Error:\n\nThe Start and End times cannot be the
same’);
      }
      else {
      if (document.form3rdspace.clipStart.value >
document.form3rdspace.clipEnd.value)
            {
                  alert(‘Third Space Error:\n\nThe End time must be greater than
the Start time’)
                  }
            else {
// generate random number to set uniqueness for ThirdSpace files
var random_number = Math.random( ) * 10000
var random_number = Math.round(random_number)
// load variable code with table holding this video quote then save it to clip array
code = ‘<table width=“240” height=“220” cellpadding=“0” cellspacing=“0”
border=“0”>\n’
code += ‘<tr>\n<td>’
code += ‘<font face=“Arial, Helv” size=“−1”>Video from:\n ‘“ + movie_final_text + ”’
(‘
code += document.form3rdspace.clipStart.value + ‘ to ’ +
document.form3rdspace.clipEnd.value
code += ‘)</font>’
code += ‘</td></tr>\n’
code += ‘<tr>\n’
code += ‘<td colspan=“3” width=“240” height=“180”>’
code += ‘<embed src=‘“ + movie_final + ‘&start=’ +
document.form3rdspace.clipStart.value
code += ‘&end=’ + document.form3rdspace.clipEnd.value
code += ”’ width=240 height=180 controls=ImageWindow autostart=false
nojava=true console=video’
code += random_number
code += ‘ backgroundcolor=#cococo></td></tr>\n’
code += ‘<tr>’
code += ‘<td width=“240” height=“26”><embed src=‘“ +movie_final
code += ‘&start=’ + document.form3rdspace.clipStart.value
code += ‘&end=’ + document.form3rdspace.clipEnd.value
code += ”’ width=240 height=26 controls=ControlPanel autostart=false nojava=true
console=video’
code += random_number
code += ‘></td></tr>\n’
code += ‘</table>’
// document.form3rdspace.body.value = document.form3rdspace.body.value += code
clip[numofclips] = code
numofclips = numofclips + 1
document.form3rdspace.body.value = document.form3rdspace.body.value +=
‘\n[Video Quote ‘ + numofclips + ’]\n’ ;
            }
    }
  }
} else alert(‘Third Space Error:\n\nA maximum of two clips can be quoted in your
post.’)
}
function postMessage( ) {
var str = document.form3rdspace.body.value
for (var i = 1; i <= numofclips; i++) {
var regexp = “\[Video Quote “ + i + ”\]”
var arvalue = i − 1
//alert(‘regexp = ’ + regexp)
// alert(‘arvalue=’ + clip[arvalue])
str = str.replace(regexp, clip[arvalue])
}
// document.form3rdspace.body.value = document.form3rdspace.body.value +=
clip[numofclips]
document.form3rdspace.body.value = str
//alert(document.form3rdspace.body.value)
document.form3rdspace.submit( )
}
//-->
</script>
<form action=“msgdone” method=“post” name=“form3rdspace”>
  <!-- Note: Edit the next 2 lines with care! --> <!-- Line 1: Will be used if the
message is a new topic -->
  <!-- Line 2: Will be used if the message is a follow-up message --> <!-- Line 3: Will
be used if the message is being edited -->
  <!-- Note: All text must appear on one line because depending on the type of post,
WebBoard will use only one of them -->
  <wb-1><font face=“Arial, Helv” size=“−1”>Post a New Topic in “<wb-
confname>”</font>
  <wb-2><font face=“Arial, Helv” size=“−1”>Reply to “<wb-follow>” in “<wb-
confname>”</font>
  <wb-3><font face=“Arial, Helv” size=“−1”>Edit “<wb-topic>” in “<wb-
confname>”</font>
  <table border=0 cellpadding=0 cellspacing=0>
  <noauth> <!-- If board is defined as “Userless” then this section will be removed --
>
  <tr>
    <td align=right> <font face=“Arial, Helv” size=“−1”> Name: </font> </td>
    <td>
    <input name=“name” value=“” maxlength=“40” size=“40”>
    </td>
    <td>&nbsp; </td>
  </tr>
  <tr>
    <td align=right> <font face=“Arial, Helv” size=“−1”> Email: </font> </td>
    <td>
    <input name=“email” value=“” maxlength=“50” size=“40”>
    </td>
    <td>&nbsp; </td>
  </tr>
  </noauth>
  <tr>
    <td align=right> <font face=“Arial, Helv” size=“−1”> Topic: </font> </td>
    <td>
    <input name=“subject” value=“” maxlength=“50” size=“40”>
    </td>
    <td> <!--  <input name=“post” type=“button” onClick=“postMessage( );”
value=“Post Message”> -->
    </td>
  </tr>
</table>
<table border=0 cellpadding=0 cellspacing=0>
  <tr>
  <td align=left> <!-- The following makes the default to Convert blank lines to
HTML paragraph tags -->
    <!-- If you want to change the default, add or remove the word “checked” -->
  </td>
  <td align=left> <!-- The following checkbox allows the user to preview the msg
before posting it -->
    <!-- If you want to change the default, add or remove the word “checked” -->
    <input name=“preview” type=“checkbox” >
    <font face=“Arial, Helv” size=“−1”> Preview message </font> </td>
  </tr>
  <tr>
  <td align=left> <!-- The following makes the default to Convert blank lines to
HTML paragraph tags -->
    <!-- If you want to change the default, add or remove the word “checked” -->
  </td>
  <td align=left width=150> <spell> <!-- If spell checking is disallowed, this
section will be automatically removed -->
    <!-- The following checkbox allows the user to preview the msg before posting it
-->
    <!-- If you want to change the default, add or remove the word “checked” -->
    </spell> </td>
  </tr>
  <tr> <anon>
  <td align=left> <!-- The following makes the msg author anonymous --> <!-- If
you want to change the default, add or remove the word “checked” -->
  </td>
  </anon>
  <td align=left> <attach> <!-- If file attachments are disallowed, this section will
be automatically removed -->
    <!-- The following checkbox allows the user to preview the msg before posting it
-->
    <!-- If you want to change the default, add or remove the word “checked” -->
    </attach> </td>
  </tr>
</table>
<br>
<wb-noattn> </wb-noattn>
<table>
  <tr>
  <td> <!-- Note: Do not remove </TEXTAREA> -->
    <textarea wrap=physical name=“body” rows=“15” cols=“45”></textarea>
  </td>
  </tr>
</table>
<br>
<hr align=“left” NOSHADE width=“288”>
<table width=“288” border=“0” vspace=“0”>
  <tr>
  <td width=“141” colspan=“3”><font face=“Arial, Helv” size=“−2”>To include
    a video segment in your post, select video clip and then enter timings
    using <!-- <a href=“javascript://” onClick=“openvideowindow(‘video’);return
false;”>Video Panel</a> timecodes.</font></td> -->
    <a
href=“http://kola.cc.columbia.edu:8080/ramgen/video/sampler/BROUGHTONvp.smil
”>Video
    Panel</a> timecodes.</font></td>
  </tr>
  <tr>
  <td width=“187” colspan=“3”> <!-- AMM removed the reset( ) in the next
statement -->
    <select name=“chooseFile”
onChange=“selectMovie(this.options[selectedIndex].value,this.options[selectedIndex]
.text)” size=“1”>
<option value=“”>Select Video Clip:</option>
<option value=“”>---------------</option>
<option value=“32_films.rm”>32 Films About Glenn Gould</option>
<option value=“tetsuo1_1.rm”>Tetsuo: The Iron Man, Cyborg</option>
<option value=“tetsuo1_2.rm”>Tetsuo: The Iron Man, Cyborg part 2</option>
<option value=“avant_garde.rm”>Ballet Mechanique, Mechanical
movement</option>
<option value=“metropolis.rm”>Metropolis, Rotwang's robot</option>
    </select>
  </tr>
  <tr>
  <td width=“50” align=“right”><font face=“Arial, Helv” size=“−
1”>Start:</font></td>
  <td>
    <input type=“text” name=“clipStart” size=“11” value=“00:00.0”>
  </td>
  <td valign=“center” align=“center” rowspan=“2”>
    <input type=“BUTTON” onClick=“blur( ); generateCode( )” value=“Add
VideoQuote” name=“BUTTON”>
  </td>
  </tr>
  <tr>
  <td width=“50” align=“right”><font face=“Arial, Helv” size=“−
1”>End:</font></td>
  <td>
    <input type=“text” name=“clipEnd” size=“11” value=“00:00.0”>
  </td>
  </tr>
</table>
<hr align=“left” NOSHADE width=“288”>
<p>
  <input name=“post” type=“button” onCick=“postMessage( );” value=“Post
Message”>
</p>
</form>
<br>
&nbsp;
</body>
```

APPENDIX B
<table width=“240” height=“220” cellpadding=“0” cellspacing=“0” border=“0”>
<tr><td><font face=“Arial, Helv” size=“−1”>Video from: “Ira Katznelson Interview”
(00:50.0 to 01:50.0)</font></td></tr>
<tr><td colspan=“3” width=“240” height=“180”><embed
src=“http://kola.cc.columbia.edu:8080/ramgen//video/sipa/sipa_katznelson.rm?embed
&start=00:50.0&end=01:50.0” width=240 height=180 controls=ImageWindow
autostart=false nojava=true console=video3205
backgroundcolor=#cococo></td></tr>
<tr><td width=“240” height=“26”><embed
src=“http://kola.cc.columbia.edu:8080/ramgen//video/sipa/sipa_katznelson.rm?embed
&start=00:50.0&end=01:50.0” width=240 height=26 controls=ControlPanel
autostart=false nojava=true console=video3205></td></tr>
</table>

What is claimed is:

1. A method for annotating audio/video data files, comprising:
a) providing one or more audio/video data files accessible via a computer server over a computer network;
b) receiving a request at said computer server from a computer of an annotating individual on the computer network for at least one of said one or more audio/video files;
c) transmitting by the computer server to the computer of the annotating individual said at least one audio/video file requested in step b) over said computer network for display by the computer of said annotating individual;
d) receiving by the computer server from the computer of the annotating individual edit point information specifying a portion of said at least one audio/video file transmitted by the computer server in step c) selected by said annotating individual;
e) receiving by the computer server text provided by said annotating individual, corresponding at least in part to said selected portion of said at least one audio/video file; and
f) storing by the computer server said text and said edit point information received from the computer of the annotating individual in an annotation data file.

2. The method of claim 1, further comprising:
g) receiving by the computer server a request for said annotation data file stored in step e) from a computer of a requesting individual on the computer network; and
h) providing by the computer server said requested annotation data file over said computer network for display by the computer of said requesting individual such that said text is displayed for said requesting individual together with said portion of said at least one audio/video file specified by said edit point information received by the computer server in step d).

3. The method of claim 1, further comprising:
g) defining at least one rule that said edit point information received from the computer of the annotating individual must satisfy; and
h) processing by the computer server said edit point information received from the computer of the annotating individual in step d) to verify said edit point information satisfies said at least one rule, wherein steps d) and h) are repeated and storing step f) is performed only if the result of step h) is that said edit point information satisfies said at least one rule.

4. The method of claim 1, further comprising:
g) defining at least one rule that said edit point information must satisfy; and
h) processing by the computer of the annotating individual said edit point information to verify said edit point information satisfies said at least one rule, wherein steps d) and h) are repeated and storing step f) is performed only if the result of step h) is that said edit point information satisfies said at least one rule.

5. A system for annotating audio/video data files, comprising:
a first storage device for storing at least one audio/video data file;
a second storage device;
a computer server comprising:
a storage device interface coupled to said first and second storage devices;
a network interface coupled to a computer network;
a first receiver coupled to said network interface for receiving an audio/video file request selecting a particular one of said at least one audio/video data file over said computer network;
a first transmitter coupled to said network interface for transmitting over said computer network the particular one of said at least one audio/video data file selected by the audio/video file request received by said first receiver;
a second receiver coupled to said network interface for receiving edit point information specifying a portion of the particular one of said at least one audio/video file transmitted by said first transmitter and for receiving text corresponding at least in part to said specified portion of the particular one of said at least one audio/video file over said computer network from a computer of an annotating individual on said computer network; and
a controller coupled to said second receiver and said storage device interface for creating an annotation data file for the specified portion of the particular one of said at least one audio/video file, said annotation data file comprising said edit point information and said corresponding text, and the controller for causing said annotation data file to be stored on said second storage device.

6. The system of claim 5, wherein said computer server further comprises:
a third receiver coupled to said network interface for receiving an annotation request selecting at least one annotation data file stored on said second storage device; and
a second transmitter, coupled to said network interface for transmitting over said computer network to a destination computer at least one annotation data file selected by the annotation request received by said third receiver;
wherein said controller creates said annotation data file so that said corresponding text is displayed at the destination computer together with said specified portion of the particular one of said at least one audio/video file.

7. The system of claim 5, wherein said computer server further comprises:
a third receiver coupled to said network interface for receiving an annotation request selecting at least one annotation data file stored on said second storage device over said computer network from a computer of a requesting individual on the computer network; and
a second transmitter, coupled to said network interface for transmitting over said computer network at least one annotation data file selected by the annotation request received by said third receiver;
wherein said controller creates said annotation data file so that said corresponding text is displayed at the computer of the requesting individual together with said specified portion of the particular one of said at least one audio/video file.
